(19) United States
(12) Patent Application Publication
(10) Pub. No.: US 2025/0190830 A1
(43) Pub. Date: Jun. 12, 2025

(54) SYSTEM AND METHOD FOR VARIATIONAL QUANTUM LINEAR SOLVER FOR EQUATIONS MODULO 2

(71) Applicant: IonQ, Inc., College Park, MD (US)

(72) Inventors: Willie ABOUMRAD, Miami, FL (US); Dominic WIDDOWS, Bellevue, WA (US)

(21) Appl. No.: 18/975,824

(22) Filed: Dec. 10, 2024

Related U.S. Application Data
(60) Provisional application No. 63/609,183, filed on Dec. 12, 2023.

(51) Int. Cl. G06N 10/20; G06N 10/40

(52) U.S. Cl. CPC G06N 10/20; G06N 10/40

(57) ABSTRACT

A system and method is provided for solving systems of binary-valued linear equations using a quantum information processing (QIP) system. The present disclosure describes solving linear systems modulo 2 on a quantum computer. An exemplary method includes defining a quantum circuit implementing matrix-vector products with a number of gates proportional to the number of non-zero entries in the coefficient matrix and then deriving a variational cost function that may be optimized to produce a solution to the given system. Compared to other quantum linear solvers, the present disclosure may work on matrices of any size and rank.

### CROSS REFERENCE TO RELATED APPLICATION(S)

This application claims the benefit of U.S. Provisional Application Ser. No. 63/609,183, entitled “SYSTEM AND METHOD FOR VARIATIONAL QUANTUM LINEAR SOLVER FOR EQUATIONS MODULO 2” and filed on Dec. 12, 2023, which is expressly incorporated by reference herein in its entirety.

### TECHNICAL FIELD

Aspects of the present disclosure relate generally to systems and methods for use in the implementation and/or operation of quantum information processing (QIP) systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, and/or control of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of systems and methods for the designing and configuration of a quantum circuit that solves systems of linear equations. Conventional systems have utilized quantum algorithms for linear systems in the past, but these systems have been focused on cases where the coefficients of a matrix may be real and complex number (e.g., real-and complex-valued matrices). For example, quantum algorithms may include Variational Quantum Linear Solver (VQLS) algorithm or the Harrow-Hassidim-Lloyd (HHL) quantum algorithm, which will be explained in more detail below. However, these quantum algorithms or systems have not been implemented to deal with binary-valued matrices, where the coefficients and solution vectors are either 0 s and 1 s.

In an exemplary aspect, the system and method described herein is configured to solve systems of binary-valued linear equations using a quantum information processing system (QIP) system. In an exemplary aspect, the variational quantum circuit design has two main components: (1) defining a quantum circuit implementing matrix-vector products with a number of gates proportional to a number of non-zero entries in a coefficient matrix, and then (2) deriving a variational cost function that can be optimized in order to produce a solution to the given linear system. The combination of such components according to the disclosed system and method accurately may accurately solve linear systems modulo 2 on a quantum computer.

Aspects of the present disclosure includes systems and methods for implementing, onto a variational quantum circuit, a quantum circuit design that implements a matrix-vector product of a m×n binary coefficient matrix and a binary vector using modulo 2 arithmetic, wherein the variational quantum circuit comprises m+n qubits; implementing, onto the variational quantum circuit, a parameterized component using N gate qubits set out in a brickwork layout for solving a linear system of Ax=b according to an ansatz with tunable parameters to provide a correct vector solution to the linear system and a cost function that serves as an optimization objective by applying a penalty to every computational basis state, wherein A corresponds to the m x n binary coefficient matrix, x corresponds to the binary vector, b corresponds to a load vector, and N is a number of non-zero entries in A; evaluating the variational quantum circuit using the brickwork layout ansatz to solve the linear system; determining measurements on the variational quantum circuit such that m qubits of the variational quantum circuit hold a result of the matrix-vector product; based on a determination that the m qubits are in a target state, determining that n qubits of the variational quantum circuit holds a solution to the linear system; and based on a determination that the m qubits are not in the target state, initiating a feedback loop on the variational quantum circuit to minimize penalty terms until an optimizer determines a lowest penalty terms.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an exemplary example of implementing an operator A as a quantum circuit in accordance with aspects of this disclosure.

FIG. 5 illustrates an exemplary of a brickwork layout ansatz on four qubits with depth of five layers in accordance with aspects of this disclosure.

FIG. 6 illustrates a quantum circuit with a full variational circuit to solve linear system in accordance with aspects of this disclosure.

FIG. 7 illustrates a method for solving systems of binary-valued linear equations using a QIP in accordance with aspects of this disclosure.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

Linear equations modulo 2 (mod 2) is referred to as modular arithmetic or arithmetic in finite fields, involve solving equations where arithmetic operations are performed modulo 2. In this context, modulo 2 means that the integers are either 0 or 1. While solving systems of equations with mod 2 arithmetic, the elementary row operations are still fundamental. However, since there is only one nonzero element (1), there is never a need to multiply a row by a nonzero constant. One other big difference is that the possible solutions is always finite. For example, if there are m linear equations in n unknowns, each unknown can only take one of two values, 0 or 1. Therefore, there are only 2ⁿ possible n-tuples to form which to draw a solution set. Assuming m≤n, typically there will be m basic variables after row-reduction and n−m free variable.

In general, solving linear systems modulo 2 has mathematical applications and commercial uses such as in integration factorization, error correction, cryptography, coding theory, Boolean satisfiability problems, network coding, and the like. For example, integration factorization relates to finding large square numbers that are products of combinations of numbers whose prime factors are known, which means the exponents should be even. The solution of some Boolean satisfiability problems can be optimized using Gaussian elimination with binary arithmetic, especially for cases with Exclusive-Or (XOR) constraints. Applications in cryptography and cryptanalysis, such as finding inverses of elements in the finite field GF(2^{m}), have encouraged research on optimizing solutions of binary linear systems. In view of these applications, the systems and methods described herein are configured to implement a matrix-vector product in modulo 2 arithmetic and a variational quantum circuit design for finding a suitable input in quantum circuits such that the matrix-vector product gives a desired output when run on gate-based quantum computers. Therefore, a component that solves linear systems modulo 2 is therefore utilized in various applications and choosing an approach typically depends on features including the dimensions, number of equations, and sparsity.

As described herein, trapped atomic ions is an example of quantum information processing approach that has delivered fully programmable machines. In trapped ion QIP, interactions may be naturally realized as extensions of common two-qubit gate interactions. Therefore, it is desirable to use entangling gates for efficient (e.g., reduced gate count) quantum circuit constructions to implement interactions in trapped ion technology. One particular interaction available in the use of trapped ions for quantum computing is the so-called Mølmer-Sørensen (MS) gate, also known as the XX coupling or Ising gate. To achieve computational universality, the Mølmer-Sørensen gate (either locally addressable or globally addressable) is complemented by arbitrary single-qubit operations, for example.

Using these principles, the exemplary system and method described herein provides for a configuration of a quantum circuit that has a plurality of qubits that solve linear systems modulo 2. In particular, the quantum circuit is configured by a quantum circuit recipe for implementing a matrix-vector product in modulo 2 arithmetic and a Variational Quantum Algorithm (VQA) on two lines designed to solve the linear system Ax=b mod 2. Furthermore, the VGA has two main components: a variational ansatz and a cost function that serves as the optimization objective. By doing so, the quantum circuit can be configured to solve Ax=b using a brickwork layout ansatz for binary-valued matrices over the field [symbol] .

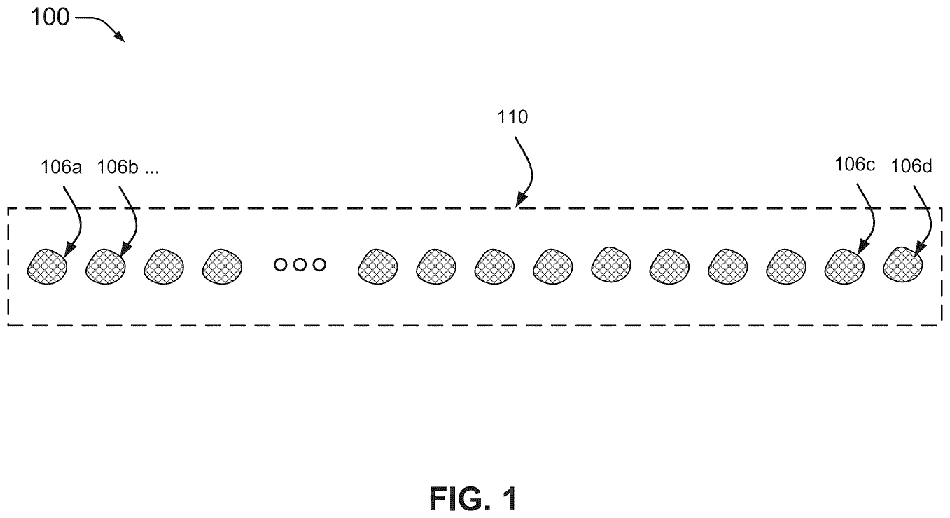

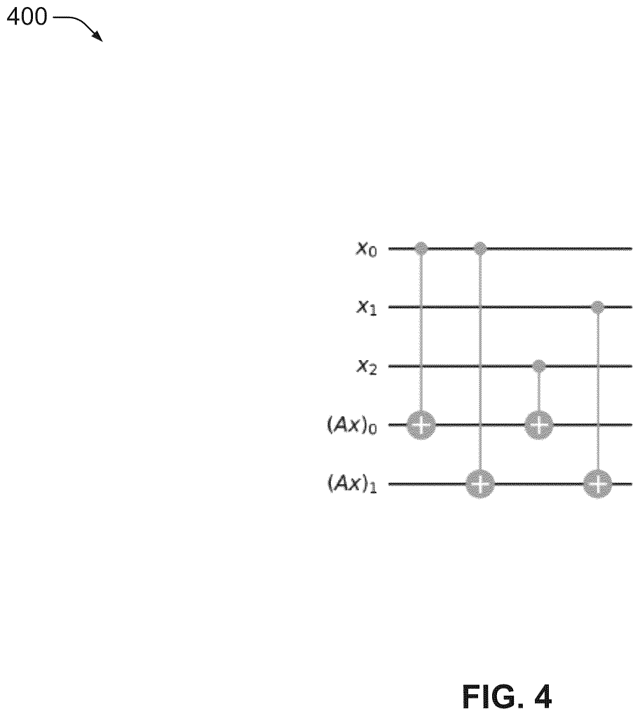

Solutions to the issues described above are explained in more detail in connection with FIGS. 1-7, with FIGS. 1-3 providing a general disclosure of QIP systems or quantum computers, and more specifically, of atomic based QIP systems or quantum computers, FIGS. 4-7 provide descriptions and examples of implementing and utilizing a system of solving binary-valued linear equations using a QIP, in accordance with various example aspects of the present disclosure.

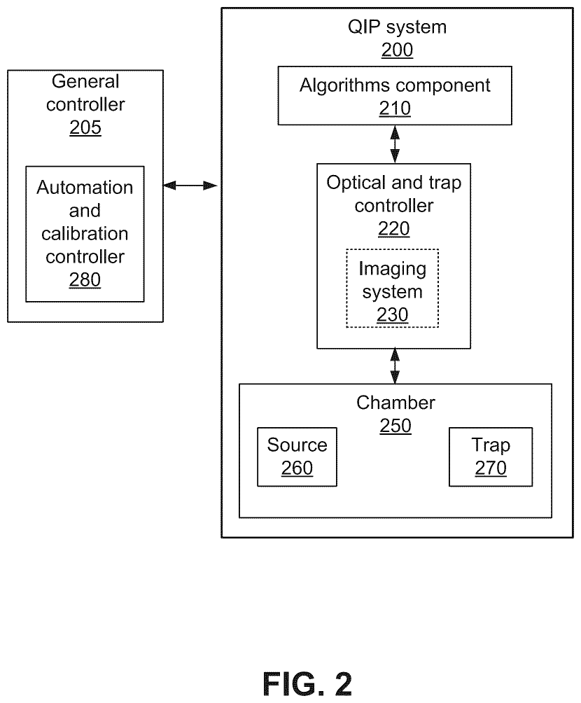

In particular, FIG. 1 illustrates a diagram 100 with multiple atomic ions 106 (e.g., atomic ions 106a, 106b, . . . , 106c, and 106d) trapped in a linear crystal or chain 110 using a trap (the trap can be inside a vacuum chamber as shown in FIG. 2). The trap may be referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110.

In the example shown in FIG. 1, the trap includes electrodes for trapping or confining multiple atomic ions (e.g., a plurality of ions) into the chain 110 that are laser-cooled to be nearly at rest. The number of atomic ions trapped can be configurable and more or fewer atomic ions may be trapped. The atomic ions can be Ytterbium ions (e.g., ¹⁷¹Yb⁺ ions), for example. The atomic ions are illuminated with laser (optical) radiation tuned to a resonance in ¹⁷¹Yb⁺ and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic Ytterbium ions, neutral atoms, Rydberg atoms, different atomic ions or different species of atomic ions may also be used. The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

As will be described in detail below, and according to an exemplary aspect, the ions in the ion trap can be configured by applying a laser (e.g., a Raman configuration) to one or more of the plurality of qubits to set a probability of a single event by rotating the one or more qubits to fix a relative angle of the at least one qubit. These details will be described below.

FIG. 2 is a block diagram that illustrates an example of a QIP system 200 in accordance with various aspects of this disclosure. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200, including the methods and algorithms described herein. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations.

In an exemplary aspect, the algorithms component 210 can be configured to break down code for quantum computations or quantum simulations into computing or gate primitives that can be physically implemented. As such, the algorithms component 210 may provide instructions to various components of the QIP system 200 (e.g., to the optical and trap controller 220) to enable the implementation of quantum circuits, or their equivalents, such as the ones described herein. That is, the algorithms component 210 can be configured to map different computing primitives into physical representations using, for example, the ion chains in the ion trap 270. Thus, the algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The lasers and optical systems (e.g., optical sources) can be at least partially located in the optical and trap controller 220 and/or in the chamber 250. For example, optical systems within the chamber 250 may refer to optical components or optical assemblies. The optical and trap controller 220 can be configured to generate one or more lasers to rotate the ions and set a probability of the respective events associate with each qubit. For example, optical sources of the optical and trap controller 220 can be configured to ionization of the atomic species, control (e.g., phase control) of the atomic ions, and for fluorescence of the atomic ions that can be monitored and tracked by image processing algorithms operating in an imaging system 230, for example.

More particularly, the QIP system 200 can include an imaging system 230 that may comprise a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the automation and calibration controller 280, and/or the algorithms component 210. These and/or components of the QIP system 200 may be used in connection with the techniques for generating and/or configuring a quantum circuit that accurately models scenarios in cognitive science that are known to violate assumptions from classical probability.

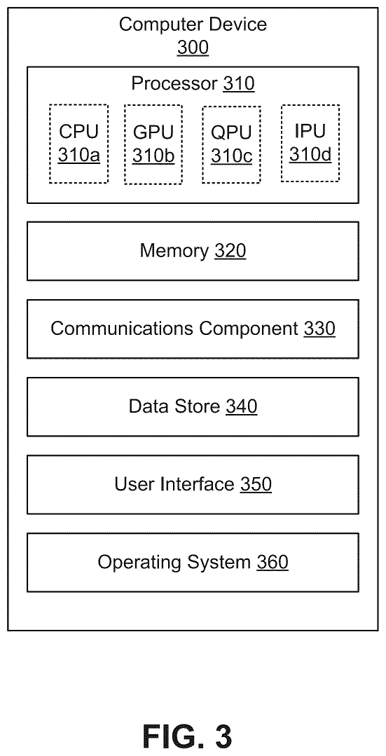

FIG. 3 illustrates is an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system that provides for performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, and with further details provided below, the present disclosure provides various aspects of techniques for quantum circuit design and configuration that solve binary-valued linear equations using controlled quantum NOT (bit flip) gates.

Conventional quantum linear solvers have included a VQLS algorithm or HHL algorithm. Quantum computing algorithms aim to leverage the unique properties of quantum mechanics to potentially solve computational problems faster than classical algorithms. Quantum computers, such as the system described above in FIG. 2, for example, are a new type of computing devices in which information is stored in a quantum system. The quantum system can be made up of a plurality of constituents, such as qubits, which are used for storing and processing information. In an exemplary aspect, the qubits can be configured by a plurality of ions in an ion trap, such as the atomic ions 106 described above with respect to FIG. 1. At the end of a quantum computation, the information can be read out by performing a measurement of at least part of the quantum system. The quantum system obeys the laws of quantum physics and thus exhibits quantum effects. Such quantum effects can be exploited to perform certain computational tasks faster than any known classical algorithms.

The VQLS algorithm is a quantum algorithm used to solve systems of linear equations, but is restricted to square matrices and invertible operations. Specifically, VQLS is designed to solve a system of linear equations of the form Ax=b, where A is a known matrix, x is an unknown vector, and b is the known output vector. VQLS uses a variational approach by employing quantum circuits and classical optimization techniques. It represents the solution vector x as the quantum state of a quantum circuit and then uses variational methods to adjust the quantum states to minimize the difference between Ax and b.

The quantum circuit in VQLS encodes the unknown solution vector x and applied unitary transformations based on the known matrix A. The circuit parameters are optimized iteratively to minimize the cost function related to the system of linear equations. Classical optimization algorithm are used to adjust the parameters of the quantum circuit to minimize the difference between Ax and b. These optimization techniques typically involve gradient-based methods to update the circuit parameters and approach the solution efficiently. The optimized quantum state is then used to estimate the solution vector x for the given linear system.

The HHL algorithm also addresses the problem of solving a system of linear equations of the form Ax=b, where A is a known matrix, x is an unknown vector, and b is the known output vector. However, similar to VQLS, HHL is also restricted to square matrices and invertible operations. HHL encodes the problem into a quantum state using techniques from linear algebra and quantum computing. The quantum state is then manipulated using quantum algorithms. HHL employs a sequence of quantum operations and quantum algorithms, including quantum phase estimation and other techniques, to perform operations on the quantum state representing the linear system. The HHL algorithm offers exponential speedup over classical algorithms for solving certain types of linear systems, especially when dealing with large, sparse matrices. However, while HHL shows a theoretical quantum speedup, practical implementations can be challenging due to the requirements for error correction, fault-tolerance, and the need for a sufficiently large, error-controlled quantum computer.

Both the VQLS and HHL algorithms solve linear equations using quantum computing have addressed the cases of real-and complex-valued matrices. However, the present disclosure addresses this problem for binary-valued matrices over the finite field [symbol] ₂ (i.e., the integers modulo 2). Accordingly, Modulo 2 Variational Quantum Linear Solver (Mod2VQLS) leverages an implementation of binary arithmetic using controlled quantum NOT (bit flip) gates.

Benefits of Mod2VQLS include being able to solve matrices of any size and rank, whereas both HHL and VQLS are restricted to square matrices with full rank (e.g., invertible operations). Because the runtime of both HHL and VQLS depends on the condition number of the coefficient matrix, HHL and VQLS assumes the coefficient matrix is not only invertible, but robustly so. The ability to work with matrices of different sizes and ranks is especially beneficial for solving problems where the matrix sizes are not fixed in advance. For example, in an integer factoring problem application, each equation (e.g., each row of the matrix A) is discovered independently in a massively-parallel data collection phase. Rather than looking for a unique solution to a fixed system of equations, the problem looks for any subset of this system of equations. Accordingly, Mod2VQLS works particularly well in this application because every possible solution to Ax=b can be part of the superposition obtained when running the optimized circuit.

In addition, while HHL and VQLS promise an exponential speed-up over classical solvers, because they leverage a dense amplitude encoding that uses log₂n qubits to represent the linear system A′x′=b′ with an n×n coefficient matrix A′, Mod2VQLS can only promise a polynomial speed-up over the fastest-known classical solvers (which are already polynomial) because Mod2VQLS uses circuits with m+n qubits for solving the system Ax=b with an m×n coefficient Matrix A.

However, the Mod2VQLS encoding furnishes several advantages that address drawbacks of HHL. For starters, in HHL the load vector b′ must be loaded onto the quantum processor. This task in itself may require an exponential number of steps with respect to the number of qubits in the circuit. By contrast, in the present disclosure, the load vector b is merely an m-bit string so it corresponds to an m-qubit computational basis state. As such, it can be efficiently loaded onto the quantum computer using at most m NOT- or Pauli X-gates.

Moreover, HHL assumes that the quantum computer may apply the unitary operator e^{-A′t} efficiently for various values of t. In the present disclosure, the closest analogue is applying the matrix-vector product operator defined below. Doing so utilizes precisely N two-qubit gates, where N is the number of non-zero entries in A. The complexity here indicates that Mod2VQLS directly benefits from the sparsity of A, which is useful in applied settings where one typically deals with large, very sparse matrices. For instances, the matrices encountered in recent large factoring calculations have millions of rows and columns, but only a few hundred non-zero entries per row.

Finally, extracting the solution vector x′ upon executing the HHL algorithm utilizes an exponential number of circuit measurements. The exponential here is with respect to the number of qubits in the HHL circuit. By contrast, in the present disclosure modulo 2 setting the solution vector x is an n-bit string, which corresponds to an n-qubit computational basis state, so it can be read-off from the optimized quantum ansatz using a fixed number of shots. In addition, another benefit of the present disclosure is that the optimized quantum ansatz obtained upon running Mod2VQLS is a superposition over computational basis states corresponding to every possible solution to Ax=b, which allows effectively sampling the solution set by measuring the optimized quantum state. This is also useful in the factoring application, where more than one element in the kernel of the coefficient matrix should be found in order to build a factor.

There are a few additional differences that distinguish the present disclosure from the conventional methods. For example, the VQLS algorithm uses a dense encoding which means that their cost function can be evaluated by executing quantum circuits with a logarithmic number of qubits. This is in contrast to the present disclosure, which requires a linear number of qubits. In contrast to the implementation details of the VQLS routine, the encoding in the present disclosure offers several benefits. For instance, in this context A is a unitary operation that can be performed using N gates, where N is the number of non-zero entries in the coefficient matrix. By contrast, the A operation in the VQLS routine is a linear combination of L unitaries, and L may be exponential in the number of qubits in their circuit. In addition, in the specific implementation of the VQLS routine, the cost function ĈG vanishes when the norm of |Ψ [symbol] vanishes, making it deficient in the sense that non-solutions to Ax=b mod 2 correspond to local extrema. By contrast, the variational state |Ψ(θ) [symbol] used here is normalized because AV (θ) is a unitary operation. Thus, there is no need to normalize the cost function, and consider more complicated local cost functions.

Conventional systems have addressed matrix multiplication and solving linear systems using quantum computing have addressed the case of real-and complex-valued matrices. However, systems have not addressed this problem for binary-valued matrices over the field [symbol] ₂. Accordingly, the present disclosure leverages an implementation of binary arithmetic using controlled quantum NOT (bit flip gates)

In connection with the systems described in FIGS. 1-3, and with further details provided below, the present disclosure provides various aspects of techniques for quantum circuit design and configuration that solves systems of binary-valued linear equations using binary coefficients and modular 2 arithmetic. The quantum circuit design has two main parts: (1) a quantum circuit recipe for implementing a matrix-vector product in modulo 2 arithmetic, and (2) a variational quantum circuit design for finding a suitable input so that the matrix-vector product gives the desired output. As described in detail below, the system and method of an exemplary aspect designs/configures a quantum circuit that solves linear systems modulo 2 on a quantum computer in such a way that the present disclosure may be implemented on matrices of any size and rank.

In an exemplary aspect, the circuit design has two main components: (1) a quantum circuit implementing matrix-vector products with a number of gates proportional to a number of non-zero entries in a coefficient matrix, which allows computation of the matrix-vector products in a quantum processor, and (2) a variational cost function that can be optimized in order to produce a solution to the given system by tuning different parameters. In some examples, the quantum circuit is implemented in the trap (e.g., as described above for FIGS. 2 and 3 by applying lasers to the respective ions in the ion trap). In an aspect, the algorithms component 210 includes code for implementing and executing the variational cost function on an input photon in the trap 270 to be executed by the general controller 205 and/or the optical and trap controller 220. The combination of such components according to the disclosed system and method solves systems of linear equations where the coefficients are 0 s or 1 s by optimizing or tuning parameters using a classical optimizer to determine a correct solution.

In general, it should be appreciated that conventional systems and works on matrix multiplication and solving linear equations using quantum computing have only addressed the cases of real-and complex-valued matrices. For example, as described in more detail above, quantum linear solves such as VQLS algorithm and HHL algorithm are quantum algorithms explicitly designed to solve linear systems of equations by leveraging quantum properties to potentially provide exponential speedup compared to classical algorithms for certain instances of the problem. In addition, both algorithms utilize the principles of quantum superposition to encode information and provide operations in parallel, which potentially leads to computational efficiency. However, neither the VQLS algorithm nor the HHL algorithm addresses this problem for binary-valued matrices.

According to an exemplary aspect, the system and method described herein is configured to create a quantum circuit for each question with a single qubit and a single gate that are configured to model one event (e.g., a single event) with two outcomes (e.g., A and not A=˜A), where a qubit in the quantum circuit is assigned to that event. A generic example of the quantum circuit implemented as a QIP system that provides for performing quantum computations and simulations is, for example, the QIP system 200 shown in FIG. 2. Moreover, the system and method are configured to apply a single-qubit rotation to set the appropriate output probability. In other words, particular rotations and ranges can be defined by the quantum system (e.g., as described above for FIGS. 2 and 3 by applying lasers to the respective ions in the ion trap) for an angle θ defined the amount of X-rotation. In this aspect, an angle θ defines the probability of the particular event.

Thus, the systems and methods described herein are configured to implement a quantum circuit for solving systems of linear equations modulo 2 and can be executed on a gate-based quantum computer in an exemplary aspect. For example, a native gate set is a set of quantum gates that can be physically executed on hardware computing systems (e.g., FIGS. 2-3) by addressing ions (e.g., the exemplary ion chain in FIG. 1) with resonant lasers via stimulated Raman transitions. The angle θ can be defined by the amount of X-rotation where single-qubit gates can be rotated along different axes on a Bloch sphere and/or as rotations along a fixed axis while rotating the Bloch sphere itself. In an exemplary aspect, the rotations can be physically implemented as Rabi oscillations that are made with a two-photon Raman transition to drive the plurality of qubits, such as the ion chain shown in FIG. 1, for example, on resonance using a pair of lasers in a Raman configuration that can be implemented by the optical and trap controller 220, for example. Moreover, the ranges can be controlled by varying the duration of the laser pulses of the Raman configuration.

There are two main parts to the circuit design system. The whole point of the circuit design system is to turn a problem of solving a linear system simultaneously into an optimization problem that may be solved by turning the parameters until a quantum state aligns with a targeted vector solution. The first part is a variational algorithm, which can be thought of as an optimization problem with a cost function such that some part of the cost function will require execution on a quantum processor. Briefly speaking, the present disclosure involves evaluating and measuring circuits on a quantum processor and performing post processing based on the measurements. The measurements are then fed into an optimizer on a classical machine. This may be a classical optimization routine that provides an update for all of the parameters in the model.

In other words, the present disclosure posits a model for the solution to the linear system with free parameters. A cost function has been designed to drive those free parameter so that the model produces a superposition over the correct solutions to this linear system.

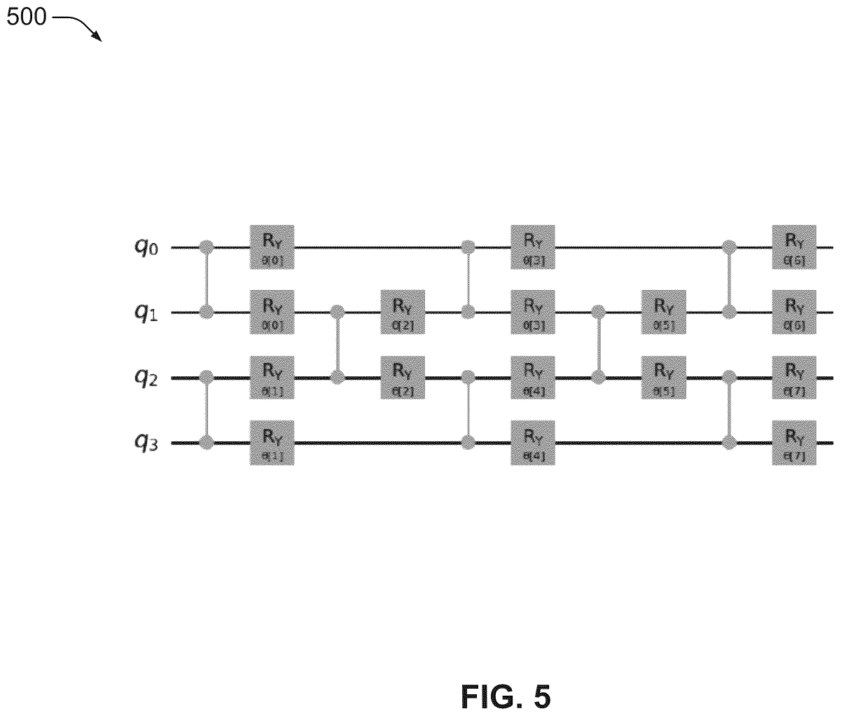

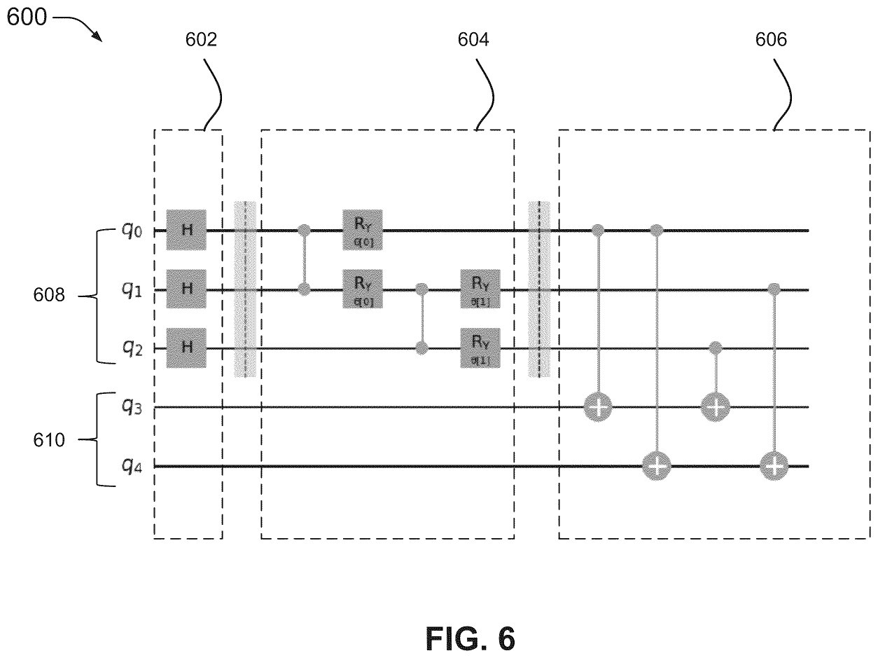

There are two main parts to the circuit, the first part is a fixed component that is a quantum circuit that implements the product of a binary coefficient matrix and a binary vector using modulo 2 arithmetic, as shown below in FIG. 4, and the second part is a parameterized component using gates set out in the brickwork layout, as described below in FIG. 5. Accordingly, the full variational circuit, as described below in FIG. 6, will include both the fixed component and the parameterized component.

FIG. 4 illustrates an exemplary example 400 of implementing the matrix-vector product as a quantum circuit in accordance with aspects of this disclosure. According to an exemplary aspect, the matrix-vector product Ax can be implemented on the quantum circuit. The matrix-vector product is fixed and specific to the linear system. The model is made up of two components, the first part allows computation of matrix-vector products in a quantum processor. Specifically, the matrix-vector products modulo 2 corresponds to a specialized arithmetic with only 0 s and 1 s.

In particular, the binary arithmetic may be implemented with controlled-NOT operations because the CNOT gate acts on the two-qubit state as Equation (1): |y, z [symbol] as CNOT|y,z [symbol] =|y, y⊕z [symbol] , with y⊕z denoting addition modulo 2. Now let |x [symbol] =|x₁, x₂, . . . xₙ [symbol] denote the n-qubit quantum state corresponding to x and notice that

$$Ax ≡ [ \begin{matrix}{a}_{11} {x}_{1} & ⊕ ⋯ ⊕ & {a}_{1 n} {x}_{n} \\ & ⋮ & \\ {a}_{m 1} {x}_{1} & ⊕ ⋯ ⊕ & {a}_{mn} {x}_{n}\end{matrix} ] mod 2.$$

Thus, the m-qubit state |Ax [symbol] can be prepared by applying the quantum circuit according to Equation (2):

$$𝒜 = {\prod }_{j = 1}^{n} {𝒜}_{j} , with {𝒜}_{j} = {\prod }_{i = 1}^{m} CNOT {( j , n + i )}^{{α}_{ij}}$$

to the tensor product |x [symbol] |0 [symbol] . Here CNOT (k, [symbol] ) denotes a CNOT gate controlled by the kth qubit and targeting the [symbol] th one. The product operator Π in these definitions is implemented by applying the gates in sequence. Note that A requires m+n qubits and N quantum gates, with N denoting the number of non-zero entries in A.

Theorem 1. In particular, using A as in Equation 2, with |0 [symbol] denoting the m-qubit all-zero state, and with |x [symbol] |0 [symbol] denoting the concatenation/tensor product of |x [symbol] and |0 [symbol] , the equation is

$$𝒜 ( \vert x 〉 \vert 0 〉 ) = \vert x 〉 \vert Ax 〉 .$$

The proof follows from an easy argument by induction on n. The base case n=1 can be easily established for all m by verifying that the ith qubit in the output register is zero precisely when aᵢⱼ=0, and the inductive step follows from a quick calculation considering the inductive hypothesis and the action of the CNOT gate, as in Equation 1.

Example 1. The following example elucidates Theorem 1. For concreteness, consider the 2×3 matrix:

$$A = [ \begin{matrix}1 & 0 & 1 \\ 1 & 1 & 0\end{matrix} ] so that Ax ≡ [ \begin{matrix}{x}_{1} & ⊕ & {x}_{3} \\ {x}_{1} & ⊕ & {x}_{2}\end{matrix} ] mod 2.$$

As shown above in Example 1, a linear system may be described by a matrix A and every row is 1 equation. Please note that in Example 1, all of the entries in the matrix are either 0 s or 1 s. This means the solution vector is also going to be made up of only 0 s or 1 s.

Then, [symbol] ₁=CNOT(1,4)CNOT(1,5), [symbol] ₂=CNOT(2,5), and [symbol] ₃=CNOT(3,4), and therefore

$$𝒜 \vert x 〉 \vert 0 , 0 〉 = {𝒜}_{3} {𝒜}_{2} \vert x 〉 \vert {x}_{1} {x}_{1} 〉 = {𝒜}_{3} \vert x 〉 \vert {x}_{1} {x}_{1} ⊕ {x}_{2} 〉 = \vert x 〉 \vert {x}_{1} ⊕ {x}_{3} , {x}_{1} ⊗ {x}_{2} 〉 = \vert x , Ax 〉 .$$

Example 400 of FIG. 4 shows how the Operator A is implemented explicitly on a quantum circuit. In other words, the matrix-vector product circuit shown in example 400 is a component of the model (or ansatz). The matrix-vector product circuit is configured to apply one of the matrices that describes the system of simultaneous equations to any quantum state and obtain the product of that bit string with the given matrix. Example 400 may be considered a fixed part of the circuit that implements the product of a binary coefficient matrix and a binary vector using modulo 2 arithmetic.

The second part is a variational quantum algorithm (VQAs), which uses a classical optimizer to train a parameterized quantum circuit using gates set out in the brickwork layout. VQAs may be implemented for essentially all applications that researches have envisaged for quantum computers. Particularly, VQAs have been developed for a wide range of applications, including finding ground states of molecules, simulating dynamics of quantum systems and solving linear systems of equations. VQAs share a common structure, where a task is encoded into a parameterized cost function that is evaluated using a quantum computer, and a classical optimizer that trains the parameters in the VQA.

FIG. 5 illustrates an exemplary of a brickwork layout ansatz on four qubits with depth of five layers in accordance with aspects of this disclosure. Specifically, a Variational Quantum Algorithm (VQA) is implemented to solve the linear system A x=b mod 2. As with any VQA, there are two main components: a variational ansatz (e.g., the model), and a cost function that serves as the optimization objective. Although there may be several different implementations for each component of the VQA, the present disclosure lists an implementation for each component for illustrative purposes only. Those skilled in the art will appreciate that there may be several other possibilities of implementing a variational ansatz and a cost function.

As illustrated in example 500 of FIG, 5, the variational ansatz takes the form |Ψ(θ) [symbol] =AV(θ)|0 [symbol] , where each θj ∈[0, 2π] is real parameters and V(0) denotes a variational quantum circuit comprised by a brickwork layout of parameterized two-qubit gates. Specifically, example 500 illustrates a brickwork layout ansatz with a depth of 5 layers on 4 qubits.

Once a model or ansatz is designed (see example 400 in FIG. 4 above), a cost function needs to be defined to tune those parameters in order to obtain a solution to the linear system. The cost function considered in example 500 measures the overlap between the projector |Ψ(θ) [symbol] [symbol] Ψ(θ)| and the subspace orthogonal to |b [symbol] , which is given by:

$$\hat{C} = tr ( \vert ψ ( θ ) 〉 〈 ψ ( θ ) \vert ( id - \vert b 〉 〈 b \vert ) ) .$$

The cost function applies a penalty to every computational basis state—every part of the quantum state that is not aligned with the target solution. In some examples, the present disclosure looks at the quantum state and if some part of the quantum state is not pointing in the same direction or aligned with the targeted solution vector, then a penalty will be applied. Accordingly, the parameters are tuned to minimize the penalty such that as the quantum state becomes more and more aligned with the targeted solution vector as the penalty is minimized.

Some algebra shows that Ĉ can be evaluated by computing the expected energy of an Ising Hamiltonian:

$$\begin{matrix}\hat{C} & = tr ( \vert ψ 〉 〈 ψ \vert ( id - \vert b 〉 〈 b \vert ) ) \\ & = 〈 ψ \vert ( id - \vert b 〉 〈 b \vert ) \vert ψ 〉 \\ & = 1 - \vert 〈 b \vert ψ 〉 {\vert}^{2} ,\end{matrix}$$

Where the dependence on θ has been omitted for the simplicity of notation. Notice that the second term is the expected value of the rank-1 Ising Hamiltonian |b [symbol] [symbol] b| with eigenvalue 1 corresponding to the eigenstate |b [symbol] and eigenvalue 0 corresponding to every other state, computed with respect to the variational state |Ψ [symbol] . Although it may be difficult to express this Hamiltonian as a linear combination of tensor products of Pauli matrices, there is no need to construct or even know it explicitly. Instead, all that is needed is an oracle that can evaluate the Hamiltonian's eigenvalues.

FIG. 6 illustrates an exemplary of a full variational circuit when solving a linear system in accordance with aspects of this disclosure. Specifically, the circuit 600 of FIG. 6 illustrates the full variational circuit evaluated by ModVQLS when solving the linear system Ax=b as described above in Example 1. In this case, the depth of the brickwork layout variational ansatz is 2.

First, at 602, there is a superposition over all possible input vectors to the linear system. Next, at 604, there is a tunable portion of the circuit that represents the ansatz. Then, at 606, the matrix-vector product circuits (e.g., fixed part) is applied. After applying the matrix-vector product, the circuit is executed and the bottom two qubits 610 are checked to see how close they are to the target state because the bottom two qubits 610 hold the result of the matrix-vector product. The goal is to get the results of the matrix-vector product (Ax) should equal the right hand side vector (b). In other words, as shown in FIG. 6, the bottom two qubits 610 are compared to see how close the bottom two qubits are to the target state. If the bottom two qubits 160 are in the target state, then the remaining top qubits 608 contain the solution to the linear system. It should be noted that in this example the bottom two qubits are checked to see whether they match the target state, but it does not necessarily always have to be the bottom two qubits that are checked against the target state and, instead, can be any subset of qubits that are checked.

If the bottom two qubits 160 are not in the target state, then, at 604, then penalty terms are applied based on how far the two qubits 160 are to the target state. The penalty terms are fed into a classical optimizer that updates the tunable parameters based on the cost. Next, the parameters of the tunable portion or the circuit are tuned according to the classical optimizer and the circuit 600 is executed again to minimize the penalty terms and get the two qubits 160 closer to the target state. In some examples, the parameters are tuned to decrease the energy observed in your Hamiltonian (e.g., cost of your Hamiltonian). The feedback loop between the quantum and classical machines to tune the parameters to seek the lowest energy, executing the quantum circuit, and then determining how close the two qubits 160 are to the target state continues until the classical optimizer decides that there is no way to update the parameters to obtain a lower cost or less penalty.

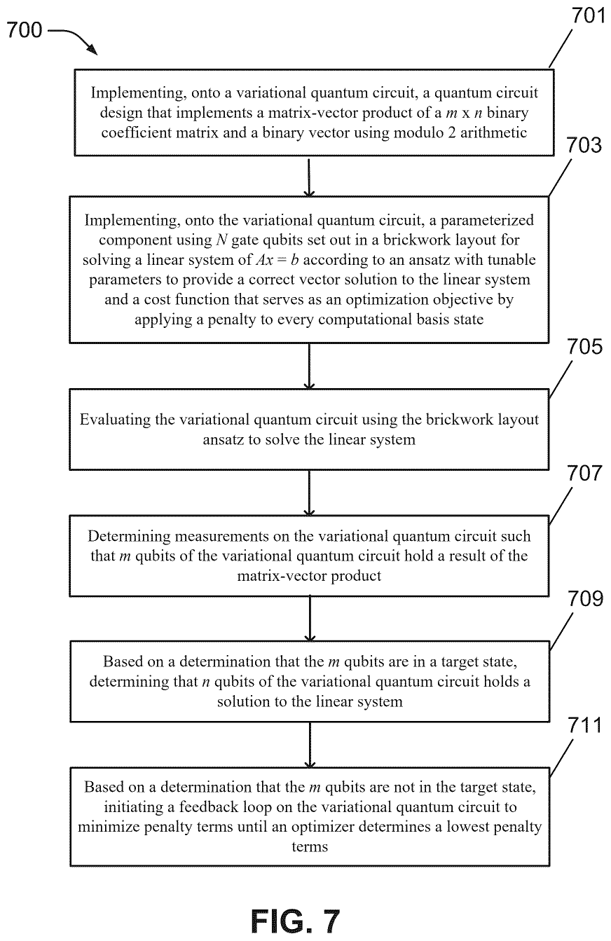

FIG. 7 illustrates a method for solving systems of binary-valued linear equations using a quantum information processing (QIP) system in accordance with aspects of this disclosure. It general, it is noted that the exemplary method 700 can be implemented using the components and systems described herein, especially with respect to QIP system 200 and general controller 205 of FIG. 2 as described above.

Next, the general controller 205 controls QIP system 200 to configuration the particular quantum circuit to solve binary-valued linear equations. In particular, at step 701, the method 700 may include implementing, onto a variational quantum circuit, a quantum circuit design that implements a matrix-vector product of a m×n binary coefficient matrix and a binary vector using modulo 2 arithmetic, wherein the variational quantum circuit comprises m+n qubits, which may be implemented by algorithms component 210, for example, of the QIP system 200.

At step 703, the method 700 may include implementing, onto the variational quantum circuit, a parameterized component using N gate qubits set out in a brickwork layout for solving a linear system of Ax=b according to an ansatz with tunable parameters to provide a correct vector solution to the linear system and a cost function that serves as an optimization objective by applying a penalty to every computational basis state. A may correspond to the m×n binary coefficient matrix, x may correspond to the binary vector, b may correspond to a load vector, and N may correspond to a number of non-zero entries in A. As an example, referring back to FIG. 5, example 500 shows an example of a brickwork layout ansatz.

In some examples, the ansatz may be a variational ansatz, the cost may be a variational cost function, and the number of qubit gates may each correspond to a two-qubit gate. In some examples, the cost function may be evaluated by computing an expected energy of an Ising Hamiltonian.

In some examples, an optimized quantum ansatz obtained upon execution of the quantum circuit design may be a superposition over computational basis states corresponding to every possible solution to Ax=b.

In some examples, the coefficient matrix may have any size and rank.

In some examples, the load vector b may be an m-bit string corresponding to an m-qubit computational basis state. In some examples, the binary vector x may be an n-bit string corresponding to an n-qubit computational base state.

In some examples, the ansatz may take a form |Ψ(θ) [symbol] =AV(θ)|0 [symbol] , where each θj ∈[0, 2π] is a real parameter, and V(θ) may denote the variational quantum circuit comprising a brickwork layout of parametrized qubit gates, wherein A may implement the matrix-vector product. In some examples, the cost function may measure an overlap between a projector |Ψ(θ) [symbol] [symbol] Ψ(θ)| and a subspace orthogonal to |b [symbol] .

The method also includes step 705, which may be implemented by algorithms component 210, for example, of the QIP system 200. As shown, this step may include evaluating the variational quantum circuit using a brickwork layout ansatz to solve the linear system.

The method may also include step 707, which may be implemented by algorithms component 210, for example, of the QIP system 200. As shown, this step may include determining measurements on the variational quantum circuit such that m qubits of the variational quantum circuit hold a result of the matrix-vector product.

The method may also include step 709, which may also be implemented by algorithms component 210, for example, of the QIP system 200. At step 709, the method 700 may include, based on a determination that the m qubits are in a target state, determining that n qubits of the variational quantum circuit holds a solution to the linear system.

The method may also include step 711, which may also be implemented by algorithms component 210, for example, of the QIP system 200. At step 711, the method 700 may include, based on a determination that the m qubits are not in the target state, initiating a feedback loop on the variational quantum circuit to minimize penalty terms until an optimizer determines a lowest penalty terms.

In some example, tuning the feedback loop may include: executing the cost function on the variational quantum circuit to assign penalty terms to each computational basis state based on how close the m qubits are to the target state; inputting the penalty terms to the optimizer on a classical determination machine configured to update the tunable parameters of the ansatz to reach a desired target state according to the penalty terms; determining the measurements on the variational quantum circuit after updating the tunable parameters in the quantum circuit design; and re-performing the feedback loop until the optimizer determines a lowest penalty terms.

In view of the foregoing, the exemplary system and method can further be configured to design and configure a matrix-vector product as a quantum circuit for a quantum computer, such as the quantum computer and system described above with respect to FIGS. 2 and 3. More particularly, the exemplary system and method can be configured to design a quantum computer circuit having two components: (1) a quantum circuit recipe for implementing matrix-vector products with a number of gates proportional to a number of non-zero entries in a coefficient matrix in modulo 2 arithmetic and (2) a VQA designed to find a suitable input so that the matrix-vector product gives a desired output in the linear system Ax=b mod 2. The combination of such components that are implemented by a quantum circuit by the disclosed system and method accurately solves systems of binary-valued linear equations using a QIP system as described above.

In general, it is noted that the foregoing description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method for solving systems of binary-valued linear equations using a quantum information processing (QIP) system, the method comprising:
implementing, onto a variational quantum circuit, a quantum circuit design that implements a matrix-vector product of a m×n binary coefficient matrix and a binary vector using modulo 2 arithmetic, wherein the variational quantum circuit comprises m+n qubits;
implementing, onto the variational quantum circuit, a parameterized component using N gate qubits set out in a brickwork layout for solving a linear system of Ax=b according to an ansatz with tunable parameters to provide a correct vector solution to the linear system and a cost function that serves as an optimization objective by applying a penalty to every computational basis state, wherein A corresponds to the m×n binary coefficient matrix, x corresponds to the binary vector, b corresponds to a load vector, and N is a number of non-zero entries in A;
evaluating the variational quantum circuit using the brickwork layout ansatz to solve the linear system;
determining measurements on the variational quantum circuit such that m qubits of the variational quantum circuit hold a result of the matrix-vector product;
based on a determination that the m qubits are in a target state, determining that n qubits of the variational quantum circuit holds a solution to the linear system; and
based on a determination that the m qubits are not in the target state, initiating a feedback loop on the variational quantum circuit to minimize penalty terms until an optimizer determines a lowest penalty terms.

2. The method of claim 1, further comprising:
executing the cost function on the variational quantum circuit to assign penalty terms to each computational basis state based on how close the m qubits are to the target state;
inputting the penalty terms to the optimizer on a classical determination machine configured to update the tunable parameters of the ansatz to reach a desired target state according to the penalty terms;
determining the measurements on the variational quantum circuit after updating the tunable parameters in the quantum circuit design; and
re-performing the feedback loop until the optimizer determines a lowest penalty terms.

3. The method of claim 1, wherein the ansatz takes a form |Ψ(θ) [symbol] =AV(θ)|0 [symbol] , where each θⱼ ∈ [0, 2π] is a real parameter, and V(θ) denotes the variational quantum circuit comprising a brickwork layout of parametrized qubit gates, wherein A implements the matrix-vector product.

4. The method of claim 3, wherein the cost function measures an overlap between a projector |Ψ(θ) [symbol] [symbol] Ψ(θ)| and a subspace orthogonal to |b [symbol] .

5. The method of claim 1, wherein the m x n binary coefficient matrix comprises any size and rank.

6. The method of claim 1, wherein the load vector b is an m-bit string corresponding to an m-qubit computational basis state.

7. The method of claim 1, wherein the binary vector x is an n-bit string corresponding to an n-qubit computational base state.

8. The method of claim 1, wherein an optimized quantum ansatz obtained upon executed the quantum circuit design is a superposition over computational basis states corresponding to every possible solution to Ax=b.

9. The method of claim 1, wherein the ansatz is a variational ansatz, the cost function is a variational cost function, and the number of N gate qubits each correspond to a two-qubit gate.

10. The method of claim 1, wherein the cost function is evaluated by computing an expected energy of an Ising Hamiltonian.

11. A quantum information processing (QIP) system for configuring a quantum circuit for solving systems of binary-valued linear equations, the QIP system comprising:
a controller configured to control a plurality of ions from the QIP system to:
implement, onto a variational quantum circuit, a quantum circuit design that implements a matrix-vector product of a m×n binary coefficient matrix and a binary vector using modulo 2 arithmetic, wherein the variational quantum circuit comprises m+n qubits;
implement, onto the variational quantum circuit, a parameterized component using N gate qubits set out in a brickwork layout for solving a linear system of Ax=b according to an ansatz with tunable parameters to provide a correct vector solution to the linear system and a cost function that serves as an optimization objective by applying a penalty to every computational basis state, wherein A corresponds to the m×n binary coefficient matrix, x corresponds to the binary vector, b corresponds to a load vector, and N is a number of non-zero entries in A;
evaluate the variational quantum circuit using the brickwork layout ansatz to solve the linear system;
determine measurements on the variational quantum circuit such that m qubits of the variational quantum circuit hold a result of the matrix-vector product;
based on a determination that the m qubits are in a target state, determine that n qubits of the variational quantum circuit holds a solution to the linear system; and
based on a determination that the m qubits are not in the target state, initiate a feedback loop on the variational quantum circuit to minimize penalty terms until an optimizer determines a lowest penalty terms.

12. The QIP system according to claim 11, further comprising:
executing the cost function on the variational quantum circuit to assign penalty terms to each computational basis state based on how close the m qubits are to the target state;
inputting the penalty terms to the optimizer on a classical determination machine configured to update the tunable parameters of the ansatz to reach a desired target state according to the penalty terms;
determining the measurements on the variational quantum circuit after updating the tunable parameters in the quantum circuit design; and
re-performing the feedback loop until the optimizer determines a lowest penalty terms.

13. The QIP system according to claim 11, wherein the ansatz takes a form |Ψ(θ) [symbol] =AV(θ)|0 [symbol] , where each θⱼ ∈[0, 2π] is a real parameter, and V(θ) denotes the variational quantum circuit comprising a brickwork layout of parametrized two-qubit gates, wherein A implements the matrix-vector product.

14. The QIP system according to claim 13, wherein the cost function measures an overlap between a projector |Ψ(θ) [symbol] [symbol] Ψ(θ)| and a subspace orthogonal to |b [symbol] .

15. The QIP system according to claim 11, wherein the m×n binary coefficient matrix comprises any size and rank.

16. The QIP system according to claim 11, wherein the load vector b is an m-bit string corresponding to an m-qubit computational basis state.

17. The QIP system according to claim 11, wherein the x is an n-bit string corresponding to an n-qubit computational base state.

18. The QIP system according to claim 11, wherein an optimized quantum ansatz obtained upon execution of the quantum circuit design is a superposition over computational basis states corresponding to every possible solution to Ax=b.

19. The QIP system according to claim 11, wherein the ansatz is a variational ansatz, the cost function is a variational cost function, and the number of N gate qubits each correspond to a two-qubit gate.

20. The QIP system according to claim 1, wherein the cost function is evaluated by computing an expected energy of an Ising Hamiltonian.
